(19) United States
(12) Patent Application Publication
(10) Pub. No.: US 2009/0279496 A1
(43) Pub. Date: Nov. 12, 2009

(54) DEDICATED AND PRIORITY BASED ALLOCATION IN MULTI-HOP WIRELESS SYSTEMS

(76) Inventors: Majid Raissi-Dehkordi, Potomac, MD (US); Karthikeyan Chandrashekar, Bethesda, MD (US); Paul M. Janes, Bethesda, MD (US); Ibrahim Utku Moral, Gaithersburg, MD (US); Pradeep K. Singh, McLean, VA (US)

Correspondence Address: ROBERT M. MCDERMOTT, ESQ., 1824 FEDERAL FARM ROAD, MONTROSS, VA, 22520, US

(21) Appl. No.: 12/435,932

(22) Filed: May 5, 2009

Related U.S. Application Data
(60) Provisional application No. 61/051,023, filed on May 7, 2008.

(51) Int. Cl. H04W 72/04

(52) U.S. Cl. 370/329

(57) ABSTRACT

A transmission channel allocation scheme for a multi-hop wireless network takes into account the priority of users, particular application requirements, applicable contractual requirements, and other factors. The channel allocation scheme determines which nodes can share a common channel for transmission without interference, and distinguishes between resources that must be dedicated to each node based on the requirements associated with each node, and the resources that are dynamically provided to each node, based on the current traffic demand. Additionally, resources that are not required to satisfy explicit requests are allocated among the nodes, thereby allowing nodes to sometimes avoid the delays associated with the access request process.

This application claims the benefit of U.S. Provisional Patent Application 61/051,023, filed 7 May 2008.

### BACKGROUND AND SUMMARY OF THE INVENTION

This invention relates to the field of communications, and in particular to a system and method for allocating time or frequency slots among wireless devices distributed across a relatively large geographic area.

The use of wireless devices continues to grow, and conventional time or frequency allocation among such devices is proving inefficient, and in some cases, inadequate to provide sufficient and reliable throughput.

In a typical wireless communication system, transmission channels are dynamically allocated to each node, based on a request for the channel by the node. Each transmission channel is different from each other in some fundamental aspect. In a TDMA (Time Division Multiple Access) network, each transmission channel corresponds to an allocated time slot; in an FDMA (Frequency Division Multiple Access) network, each transmission channel corresponds to an allocated frequency slot; and in a CDMA (Code Division Multiple Access) network, each transmission channel corresponds to an allocated code, or code-phase. For ease of reference and understanding, the invention is presented using the paradigm of a TDMA network in which time-slots are allocated to transmitters that request access. One of skill in the art will recognize that the principles presented herein are equally applicable to FDMA and CDMA networks, as well as other networks that may use a different allocation technique, including a combination of allocation techniques.

In a TDMA system, a given time ‘frame’ is partitioned into a number of time ‘slots’. At each frame, the time slots are allocated among requesting transmitters. Typically, each node that has information to transmit requests access to one or more slots during a ‘beacon’ period before the transmission time frame, and receives an identification of the allocated time slot(s) at which it is authorized to transmit. The beacon signal from each node may also include an identification of the intended recipient(s) of the transmission(s), and the allocation response serves to also inform each of the intended recipients when to expect transmissions from other nodes.

Network performance is significantly affected by the techniques used for allocating transmission channels among a number of nodes. As network complexity increases, and/or the amount of traffic increases, the number of requested slots may exceed the finite number of time slots in the frame, and the allocation scheme will need to select which of the requesting nodes are to be allocated time slots, and which requests are to be denied. As each request is denied, a backlog builds at the denied node, and the problem is compounded as the denied nodes continue to request access at each subsequent frame. If the allocation is ‘fair’, all nodes will share in the degraded performance caused by their denied requests. However, some applications, such as streaming video, may have a low-threshold for the amount of degraded performance experienced, effectively resulting in a ‘failure’ of the network with regard to these applications when this threshold is exceeded. Accordingly, some nodes will be given priority, resulting in other nodes experiencing more than their fair-share of the degradation.

Additionally, some allocation schemes may be inherently more efficient than others in terms of satisfying access requests. Although it would be desirable to provide the maximum traffic capacity at each time frame, this generally requires some level of traffic control or traffic smoothing, to avoid combinations of underutilized frames and overdemanded frames, and some allocation schemes are better suited than others for particular types of traffic flow. In like manner, some allocation schemes are better suited than others for supporting increases in network size and complexity.

Because wireless networks can be very dynamic when it comes to the size of the network, the efficient allocation of resources among wide ranging networks is becoming increasingly important.

FIG. 1 illustrates an example diagram of a wireless network comprising nodes A-H distributed over a geographic area. Each wireless node has a range within which it may communicate with other nodes, the example ranges for nodes being illustrated by dashed circles and arcs. As illustrated, node A's range extends to nodes B and C, but does not include D-H; in like manner, node G's range extends to nodes F and H, and does not include A-E.

A message from node A to node G must be relayed through nodes C, E, and F. Conventionally, the use of each link along a route is termed a “hop”, and the transmission of the message from A to G uses four hops, A-C, C-E, E-F, and F-G. Each of these four hops will require the allocation of a time slot in each of four time frames. This multiplicative effect on a multi-hop network significantly increases the overall demand for network resources, further increasing the need for efficient channel allocation in multi-hop wireless networks. Consider, for example, a time-slot duration of 1 ms; if a hundred unit-length messages are sent from node A to node G, 400 milliseconds would be required to transmit these packets using a simple linear TDMA allocation. However, if it is recognized that the transmissions from node F to node G cannot interfere with transmissions from node A to node C, and vice versa, then when the first message is being sent from node F to node G on an allocated channel, the second message can be sent from node A to node B on the same channel. In this manner, it can be shown that these hundred messages can be sent from node A to node G in 301 milliseconds (3*99+4), thus resulting in a savings of just under 25%.

“A Unified Framework and Algorithm for (T/F/C)DMA Channel Assignment in Wireless Networks”, Ram Ramanathan, Proceedings of the IEEE INFOCON 1997, Kobe (Japan) 1997, hereinafter Ramanathan, presents an efficient algorithm for allocations in a multi-hop network based on relatively simple observations: two nodes in direct communication with each other cannot both transmit on the same channel without interfering with each other, and two nodes in direct communication with a third node cannot both transmit on the same channel without interference at the third node.

A directed graph provides a convenient representation of wireless communication networks, wherein each network node forms a vertex of the graph, and each direct link between nodes is represented as an edge. FIG. 2 illustrates an example directed graph corresponding to the network of FIG. 1. For ease of illustration and understanding, each link is bi-directional in this example, although the use of a directed graph, and the principles of this invention, are not limited to bi-directional links.

FIG. 2 also identifies which nodes cannot share a common transmission channel, using the principles presented in Ramanathan. For example, node A cannot share a transmit channel with nodes B, C, and E, because node A is in direct communication with nodes B, and C, and both node A and node E are in direct communication with node C. In like manner, node E cannot share a transmit channel with any other node because it is in direct communication with nodes C, D, and F, and nodes E, A, and B are in direct communication with node C, and nodes E, G, and H are in direct communication with node F.

FIG. 3A illustrates a simple linear TDMA allocation of example requests during a sample time frame. In this example, node A has requested four time-slots, node B has requested three time-slots, and so on, and a total of 23 time-slots (0-22) are allocated to support these requests.

FIG. 3B illustrates an example TDMA allocation using the channel sharing techniques presented in Ramanathan. In this example, channels (time-slots) are allocated in alphabetical order; the first four time-slots are in response to node A's requests, the next three are in response to B's request, and so on. In accordance with Ramanathan, as each request is processed, each time slot is checked to determine whether it can be used by the requesting node. As noted above, nodes A, B, and C cannot share a transmit channel, and thus their requests are allocated sequentially. Node D, on the other hand, can share a transmit channel with channels A and B, and when its requests are processed, time-slots 0-4 are allocated to node D, even though they have also previously been allocated to nodes A and B. In like manner, node F can share a transmit channel with node B and is allocated time-slots 5-6. Node E, on the other hand, cannot share a channel with any other node, and thus is allocated the next-available unallocated time-slots 9-11. Nodes G and H are not prohibited from sharing transmission channels from either A, B, or D, and thus node G is also allocated time-slots 0-1, and node H is allocated time-slots 2-4. As can be seen, by allocating slots based on allowable sharing in this example reduces the total amount of time required by half.

The efficiency of the allocation of channels based on allowable sharing can be affected by the order in which the node requests are processed. In FIG. 3B, the nodes are processed in an arbitrary (alphabetic) order. Ramanathan provides an assessment of three different ordering techniques: random, minimum neighbor first (MNF), and progressive minimum neighbor first (PMNF), and determines that the progressive minimum neighbor first (PMNF) technique generally performs best. A problem with these ordering techniques, however, is that they do not match well with typical network requirements. The random technique is obviously not influenced by actual network requirements, and the MNF and PMNF techniques are based on connectivity, independent of actual traffic flow and network requirements.

In most networks, different users have different priorities, and contractual matters often grant different rights to service among users. It would be advantageous to provide an allocation scheme that accommodates the requirements of the network in which it operates. It would also be advantageous to provide a tool that assesses a proposed allocation scheme for an existing or proposed network.

These advantages, and others, can be realized by an allocation scheme for a multi-hop wireless network that takes into account the priority of users, particular application requirements, applicable contractual requirements, and the like. Preferably, the allocation scheme distinguishes between resources that must be dedicated to each node based on the requirements associated with each node, and the resources that are dynamically provided to each node, based on the current traffic demand. Additionally, recognizing that unallocated resources that are unused represent an inefficient use of channel resources, resources that are not required to satisfy explicit requests are allocated among the nodes, thereby allowing nodes to sometimes avoid the delays associated with the access request process.

### BRIEF DESCRIPTION OF THE DRAWINGS

The invention is explained in further detail, and by way of example, with reference to the accompanying drawings wherein:

FIG. 1 illustrates an example multi-hop wireless network.

FIG. 2 illustrates a directed graph corresponding to the multi-hop network of FIG. 1.

FIGS. 3A and 3B illustrate the allocation of channels based on two prior art allocation methods.

FIG. 4 illustrates an example flow diagram of an allocation method in accordance with this invention.

FIG. 5 illustrates an example block diagram of an allocation engine/machine in accordance with this invention.

FIG. 6 illustrates an example block diagram of a simulation engine/machine in accordance with this invention.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

As noted above, the invention is presented herein using the paradigm of a TDMA network in which time slots are allocated within each time frame, based on requests from nodes that have traffic to transmit, although the principles presented herein are applicable to a variety of resource allocation techniques, including FDMA and CDMA. For ease of reference and understanding, messages are considered to comprise one or more packets, each packet requiring one time slot for transmission. The term ‘packet’ is used in the general sense, representing a unit of message information, regardless of how this information is formatted for transmission. For example, a continuous transmission of information over ‘n’ time slots can be considered to comprise ‘n’ packets, for ease of illustration and understanding.

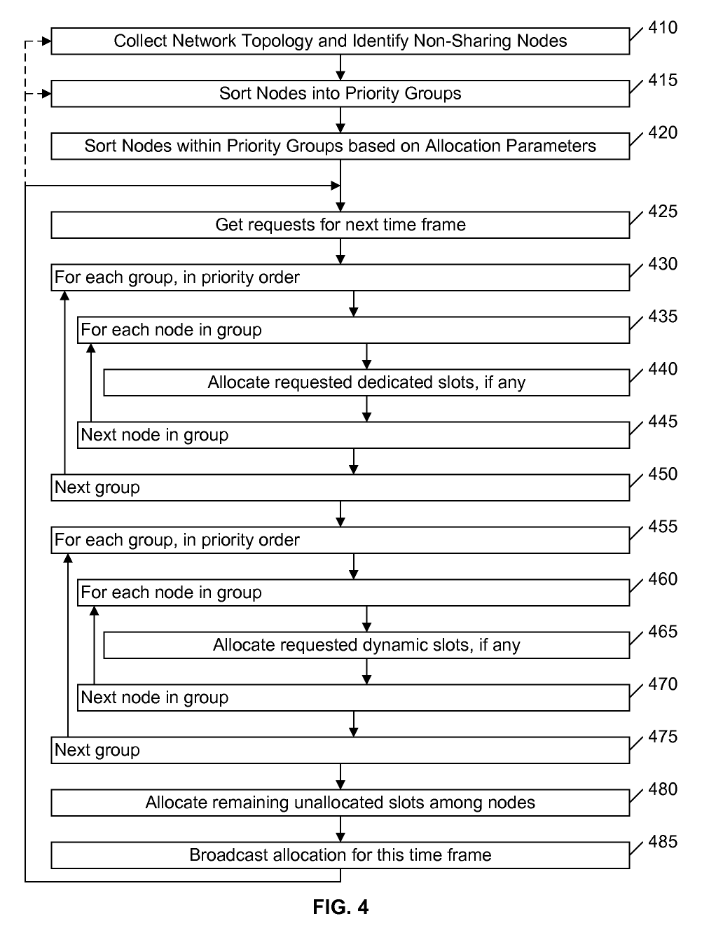

FIG. 4 illustrates an example flow diagram for a transmission channel allocation method in accordance with this invention.

At 410, the network is assessed to determine topology, and to determine therefrom the sets of nodes that cannot share a common channel. Any of a variety of techniques may be used to determine topology, including the common technique of having each node broadcasting a list of its known neighbors. In a preferred embodiment of this invention, the algorithm presented in [Ran], above, is used to identify nodes that are not permitted to concurrently transmit on a common transmission channel, although any other technique for identifying nodes that should not share a common transmission channel may be used.

At 415, the priority associated with each node is determined, and used to distinguish sets/groups of nodes of differing priorities. The priority of a node may be set by any of a variety of techniques. Nodes that are providing multimedia information, for example may be given a higher priority than nodes that are providing textual information. In some situations, nodes that have subscribed to a generally higher level of service, with an associated higher level service fee, are given priority over nodes that have subscribed to lower levels of service.

At 420, the priority of nodes within each group is determined, based on any of a variety of allocation parameters. For example, the group priority may be established based on purchased levels of service, and the priority within the group may be established based on the type of application each node is expected to provide.

Although group and node priorities are criteria for allocation of resources, it is recognized that contractual or promised service commitments are often of primary concern to the service provider. For example, many service contracts provide an assurance of at least some minimum bandwidth, or throughput. In an example frame comprising one hundred slots of 100 microsecond duration, each slot comprising a hundred bytes, a promised 100 kbs bandwidth corresponds to a promise of ten slots per frame (100 frames/second*10 slots/frame*100 bytes/slot=100000 slots/second). When a node that has been promised ten slots per frame has data to transmit, at least ten slots per frame should be allocated to the node, regardless of the priority of the node. In the context of this disclosure, the satisfaction of a promised allocation is termed a dedicated allocation.

Generally, a provider will not promise/dedicate more time slots to client nodes than are available in a frame. However, both the provider and client realize that not every client will be demanding service at every frame, and therefore there will be spare resources that can be allocated dynamically, as the demands vary, and the provided bandwidth will generally exceed the promised minimum bandwidth. In the context of this disclosure, the satisfaction of a requested demand in excess of the guaranteed minimum allocation is termed a dynamic allocation.

At 425, the requests from the nodes in the network are collected to determine the demand for the next time frame. As noted above, such requests are commonly submitted via beacon signals from nodes that have data to transmit.

For ease of understanding, it is assumed herein that the promised level of service takes precedence over the node or group priorities. One of skill in the art will recognize, however, that the relative significance of promised service and node or group priority may differ in different embodiments. For example, in some embodiments, the priority levels may include levels of “paying customers” and levels of “non-paying customers”. In these embodiments, the satisfaction of promised service among non-paying customers may be addressed only after satisfying all of the current demands of the paying customers, including those demands that exceed the promised service to the paying customers. In other embodiments, the priority levels may be absolute, and the dedicated and dynamic allocations may be addressed within each group priority level before the demands of the nodes in the next group priority level are addressed. That is, one of skill in the art will recognize that the particular order of processing the demands from the nodes may differ from the example flow 430-475 of FIG. 4.

Not illustrated in FIG. 4, if the level of requests for a given frame is below the level of available time slots, such that the requests can be satisfied by a straightforward linear allocation, the following steps need not be taken.

In the loop 430-450, all of the requests from the nodes are addressed to assure that the promised allocation level is provided. In this embodiment, the nodes are processed in their group order, although if the provider does assure that the promised allocation level is always lower than the available time slots, this order of processing can be ignored. In the inner loop 435-445, the requests of each node in each group is assessed, in priority order if necessary, and any request within the limit of the promised minimum allocation is satisfied by allocating slots to satisfy this dedicated allocation.

At 440, the requests within the promised allocation for each node are processed to allocate one or more channels to satisfy the request. Preferably, the allocation scheme of Ramanathan is used for an efficient allocation with a multi-hop network, although any allocation scheme may be used, including, for example, a simple linear allocation when traffic demands are low enough to be satisfied by this technique.

Of particular note, all nodes are processed to provide the dedicated allocation, before dynamically allocating slots in excess of the dedicated allocation, at 455-475.

In the loop 455-475, requests from each node in excess of its minimum promised allocation are addressed. The outer loop 455-475 processes the groups in priority order, and the inner loop 460-470 processes each node in priority order within each group.

At 465, the same allocation scheme as used at block 440 is used to allocate channels to satisfy the as-yet-unsatisfied demands for the next time frame, although different allocation techniques may be used as desired. For example, one allocation scheme may be particularly well suited for allocating blocks of channels to provide dedicated allocations, while another may be preferred for allocating individual channels to provide dynamic allocations.

After all requests for transmission channels have been satisfied, some channels may often remain available. In conventional systems, these channels generally go unused, as the allocation has satisfied all of the known demands.

In accordance with one aspect of this invention, it is recognized that between the time that a channel is requested by a node and the time that the allocated channel is used, other data may have been queued for transmission from the node. Therefore, regardless of an explicit request, all of the remaining available time slots are preferably allocated, at 480. When the allocation is published, at 485, the nodes will receive notification of allocations based on their requests, as well as unrequested allocations. If a node has data to send at the time that the unrequested allocation arrives, it can send that data during the allocated time slot, thereby avoiding the delay incurred by having to explicitly request a time slot.

In a preferred embodiment, the remaining available time slots are allocated to the nodes that have requested time slots, in proportion to their requested demands, based on the assumption that most communications are continuous across a number of time frames. That is, if the node is transmitting a continual message, providing the intermediate unused time slots will facilitate efficient transmission of the message. Once the message is terminated, the requests will cease and the available slots will be allocated to nodes that have ongoing requests. Other techniques for allocating otherwise unallocated channels may also be used, including, for example, a straightforward uniform or priority-weighted distribution among all the nodes.

Preferably, the allocation of available channels among the nodes that are to receive the allocation is provided using the allocation technique of Ramanathan, so that the advantages of channel sharing can be realized. One of skill in the art will realize that this allocation of available channels in not limited, per se, to the as-yet-unallocated channels. That is, for example, in the allocation of FIG. 3B, the allocation need not be limited to time slots 12-23. For example, time slots 7-8 are available for unrequested allocation to nodes G and H. Also, one of skill in the art will recognize that a straightforward technique of allocating unused channels may be to replicate prior allocations. For example, in the example of FIG. 3B, the allocations of time slots 0-11 may be repeated for time slots 12-23.

After processing all of the requests for the time frame, and broadcasting the determined allocation at 485, the allocation process 425-480 is repeated for the next time frame. Optionally, the repeated process may include a redetermination of priority, as indicated by the dashed-arrow to block 415. To avoid having low-priority nodes completely bypassed during periods of traffic saturation, each time that a node's request is not satisfied, it's priority level is increased, so that eventually, it achieves a high enough priority to be allocated a transmission channel ahead of other nodes.

It is significant to note that the above partitioning of demands between dedicated and dynamic allocations assumes that each message from a node can be arbitrarily partitioned into independent packets. One of skill in the art will recognize that if a message, or parts of a message, must remain contiguous in transmission, this requirement can be conveyed to the allocation blocks 440, 465, and these blocks can be configured to allocate multiple contiguous channels to satisfy such demands.

Also illustrated by dashed lines in FIG. 4, in a mobile environment with a potentially changing topology, the allocation process includes reassessing the topology to update the sets of non-sharing nodes as required. This reassessing may occur at regular intervals, and/or upon the occurrence of particular events, such as receipt of a notice that a node's connectivity has changed.

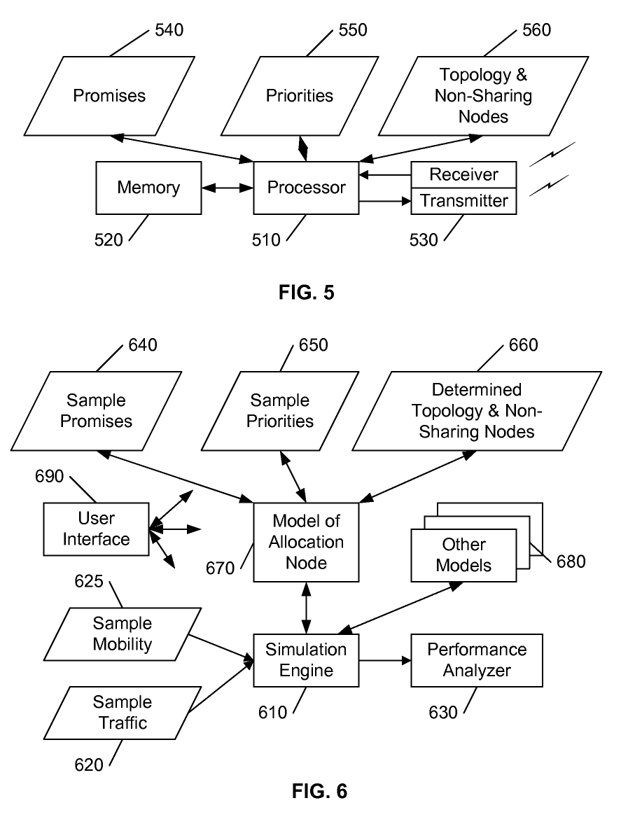

FIG. 5 illustrates an example block diagram of a node that is configured to provide channel allocation in accordance with this invention. The choice of which node is to perform this function is generally dependent upon the particular network. In a commercial network, such as one established by an “Internet Café”, the node at the provider location is the likely choice for controlling the allocation. In a business network, such as an office network, a hub-node that is dedicated for support of the network would be the likely choice. In an informal network, the node that initially establishes the network would likely provide this access control, if it is suitably equipped to perform this function, otherwise, a more capable mode is selected by the original node. One of skill in the art will recognize that any of a variety of other schemes may be used, including, for example, selection based on location in the network, a central location being preferred for efficient interactions.

A processor 510 is configured to control the operation of the node, typically based on machine instructions that are stored in a memory 520, the machine instructions being an executable embodiment of a computer program that provides some or all of the functions of the method of FIG. 4.

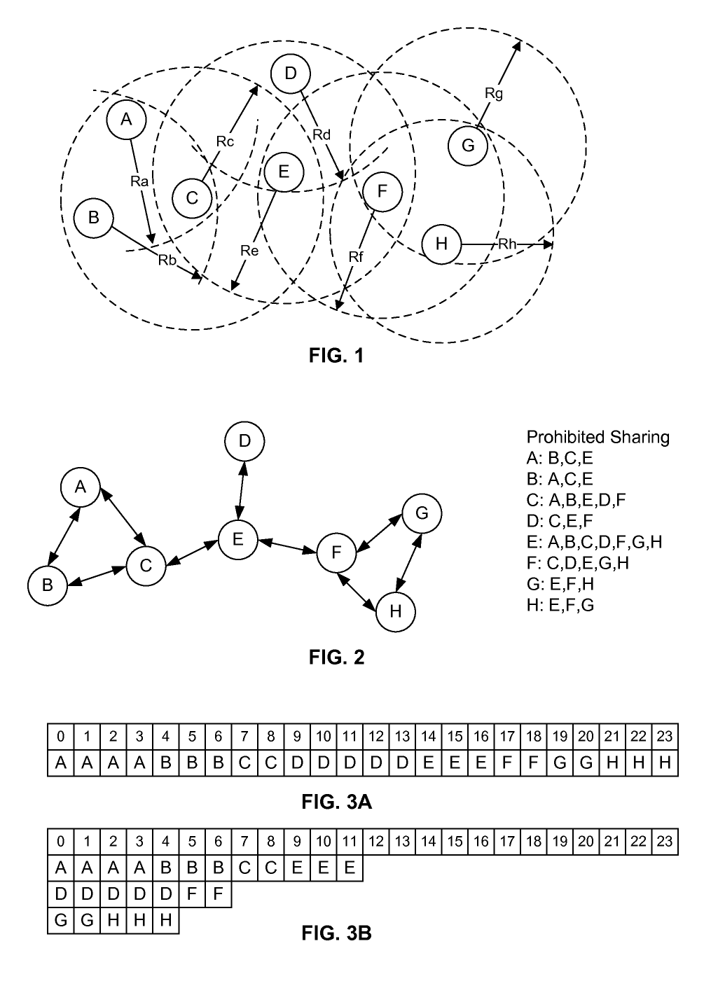

A transceiver 530 is configured to provide communication with other nodes on the network, such as the network illustrated in FIG. 1. Consistent with conventional techniques, the nodes are each configured to broadcast information regarding its connectivity, and particularly, connectivity to its immediate neighbors.

Based on the connectivity information from the other nodes, as well as the connectivity of this node, the processor 510 creates a topological description 560, preferably in the form of a directed graph as detailed in Ramanathan, so that the identification of sets of nodes that are not permitted to share channels can be readily identified, as also detailed in Ramanathan, and as discussed above with regard to FIG. 2.

As discussed above, in a preferred embodiment of this invention, a priority of communication 550 is defined for each node. In a commercially provided network, priorities may be based on a level of purchase price; in a business network, priorities may be based on job-function; in a home network, priorities may be based on the type/class of information that is expected to be transmitted from each node; and so on. Commonly, the priority levels are generalized, and not specific to particular nodes or functions, using, for example, a priority scale of 1 to 10 or a set of ‘low’, ‘medium’, and ‘high’ priorities, such that there will likely be a number of nodes having the same priority level. Optionally, the relative priority of each node within each group is also defined, either in a specific numerical ordering, or again in sets of generalized priority.

In addition to priority levels, any promises 540 made for levels of service may also be defined. The term ‘promise’ is used herein to include any implied, expressed, or assumed level of service that the provider identifies. In a commercial network, the purchase price may contractually provide for a guaranteed minimum level of service, or an advertisement may imply a certain minimum level of service. In like manner, if an Internet Café provider adopts a “better to turn away than to disappoint” principle, this provider may set a default minimum level of service that is also used to deny entry into the network when this level cannot be assured for each node already accepted into the network. In a home network, if any node has a required minimum level of service to operate properly, such as a multimedia player, or an Internet-phone, the homeowner will specify this requirement as a promised level of service.

In a preferred embodiment of this invention, these promises 540 are defined in terms of a minimum number of slots within each frame that will be dedicated to the node whenever the node requests such slots for transmission. In some embodiments, it may be known that a particular node will be transmitting continually, and these dedicated slots for this node may be allocated in each frame regardless of receipt of an explicit request. In like manner, for a node that generally provides bursts of data, its dedicated slots may be automatically allocated for a given number of frames upon receipt of an initial request at the start of each burst. For ease of reference, the dedicated slots that are allocated without an explicit request are defined to be allocations of dedicated slots in response to implied requests, and the term ‘request’ as used herein includes both implicit and explicit requests.

Using these defined promises 540, priorities 550, and non-sharing nodes 560, the processor 510 responds to each set of requests received from the other nodes before each time frame, as provided in the example process of FIG. 4.

As noted above, a node's request is not limited to the number of slots that it has been promised. For ease of reference, a request for a number of slots in excess of the number of promised dedicated slots is termed a request for that number of dynamic slots. Depending upon the adopted request protocol, each node may send one request that includes an entirety of the node's requests, or may send individual requests, wherein dedicated and dynamic slots are distinguished, and/or different addressees are distinguished. One of skill in the art will recognize that the particular form of the requests is immaterial to the principles of this invention.

Of particular note, in accordance with an aspect of this invention, the processor 510 is configured to allocate all requested dedicated slots, before any requests for dynamic slots are granted, regardless of the priority of the nodes, or at least regardless of the priority of the node within a common priority grouping of nodes.

Although the promises are preferably structured to assure that each request for a dedicated slot is satisfied, in many situations, a reasonable risk of over-commitment may be acceptable, because the available number of allocatable channels in a multi-hop environment with shared channels varies dynamically, and the likelihood of all nodes requesting all of their dedicated channels is likely to be low. If the possibility exists that all promises may not be satisfied, the processor 510 allocates dedicated slots in order of group and node priorities. In like manner, after allocating all of the requested dedicated slots, if the possibility exists that remaining requests may not be satisfied, the processor 510 allocates dynamic slots in order of group and node priorities.

One of skill in the art will recognize, however, that there may be little benefit derived from determining whether all requests for dedicated and dynamic slots can be satisfied a priori, and the processor 510 may be configured to always process requests in priority order, regardless of the requested allocations, as illustrated at 430-475 in FIG. 4.

After allocating all of the dedicated and dynamic slots, the processor 510 determines whether there are any available slots remaining, and allocates these remaining slots among the nodes, using any of a variety of allocation schemes, as discussed above with regard to block 480 of FIG. 4. In a preferred embodiment, if processing time is available, an iterative reassessment is performed to assess the allocations throughout the frame to determine where other shared allocations can be provided.

As is readily apparent from the above, the choice of priorities and the levels of promised service will determine the order in which requests are satisfied, and it is well known in the art that the order of allocation can significantly affect the overall efficiency of the allocation with regard to taking advantage of sharable channels, as well as the overall effectiveness of the allocation to satisfy promises, or the overall effectiveness of the promises satisfying application or user requirements.

In accordance with another aspect of this invention, the method of allocation of FIG. 4 is also used in a simulation system to facilitate an evaluation of the achievable efficiency and effectiveness of different choices of priorities and levels of promised services under a variety of expected traffic conditions.

FIG. 6 illustrates an example block diagram of a simulation system in accordance with an aspect of this invention. A simulation engine 610 is configured to simulate the operation of a wireless network given a sample set of traffic 620, and a sample set of mobility 625 among the wireless nodes of the network. The sample traffic may be generated based on observed traffic among nodes of an existing network and/or expected traffic among such nodes, or among nodes of a hypothesized network.

The simulation engine simulates the propagation of the sample traffic 620 within the network as the wireless nodes are simulated as being positioned geographically based on the sample mobility 625. The simulation engine propagates the generated traffic and other messages among the models 680 of the nodes of the network, including a model 670 of the allocation node. The model 670 of the allocation node is configured to exercise the same functions as the actual node as detailed above with respect to FIGS. 4 and 5. The simulation of the network will include, for example, the communication of connectivity information among the nodes, and the model 670 will determine the indicated topology, from which the sets of non-sharing nodes 660 are determined. Thereafter, after simulating the establishment of the network, the sample traffic is generated and propagated across the modeled network.

As in the actual network, the model 670 of the allocation node will receive requests from the models 680 of the other nodes, based on the sample traffic 620, and will allocate dedicated and dynamic channels based on the promises 640 and priorities 650 associated with each node. If any channels of the transmission frame remain available, the model 670 of the allocation node will also allocate these remaining available channels among the nodes, then provide the allocation to the simulation engine 610 for broadcast to the models 680 of the nodes.

Based on the broadcasted allocation, the models 670, 680 of the nodes having traffic to send will provide their traffic at their allocated times, and the simulation engine 610 will correspondingly propagate this traffic through the modeled network. This process is repeated for each transmission frame until the simulation is terminated by the user or by the cessation of sample traffic 620.

The resultant propagation of traffic across the modeled network is assessed by a performance analyzer 630 to determine any of a variety of performance measures. For example, the sample traffic 620 may specify a particular pattern of traffic from a source node to a destination node, and the performance analyzer 630 may determine such factors as the distribution of observed delay between the time each packet of the message is generated, and the time that it is received at the intended destination, or the distribution of accepted/rejected requests, and so on.

A user interface 690 is provided to facilitate the simulation of the network under different combinations of promises 640 and priorities 650. Typically, a user will establish a sample set of promises 640 and priorities 650, run the simulation using the sample mobility 625 and traffic 620 patterns, assess the resultant performance, then repeat the process after modifying one or more of the sample promises 640, priorities 650, mobility 625 or traffic 620. In this manner, the selection of preferred promises 640 and priorities 650 for use as the promises 540 and priorities 550 in the actual allocation node of FIG. 5 can be made, based on the simulated performance of the network under expected traffic 620 and mobility 625 conditions.

The foregoing merely illustrates the principles of the invention. It will thus be appreciated that those skilled in the art will be able to devise various arrangements which, although not explicitly described or shown herein, embody the principles of the invention and are thus within its spirit and scope. For example, in addition to assessing a variety of possible priority and promise situations on the network, the simulation system can be configured to assess the expected performance of the network based on a variety of frame sizes, time slot durations, and so on. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements, and can include an immeasurable number of elements.

We claim:

1. A method embodied in a machine comprising:
receiving connectivity information from nodes of a plurality of nodes in a network,
determining sets of non-sharing nodes based on the connectivity information, each set identifying nodes that are not permitted to share a transmission channel, at least some of the nodes in the plurality of nodes being permitted to share a transmission channel,
receiving requests from a plurality of requesting nodes for allocation of transmission channels within a transmission frame,
providing a first allocation of dedicated transmission channels in response to the requests based on a promise of dedicated channels associated with each requesting node,
providing a second allocation of dynamic transmission channels in response to requests in excess of the promise associated with each requesting node, and
broadcasting the first and second allocations to the plurality of nodes to enable the transmission of data from the requesting nodes based on these allocations,
wherein the first and second allocations include one or more allocations of a same transmission channel to a plurality of requesting nodes.

2. The method of claim 1, including providing a third allocation of available transmission channels remaining after the first and second allocations.

3. The method of claim 1, wherein determining the sets of non-sharing nodes includes identifying nodes that are in direct communication with each other and identifying nodes that are in direct communication with a common other node.

4. The method of claim 1, wherein determining the sets of non-sharing nodes includes creating a directed graph based on the connectivity information.

5. The method of claim 1, wherein the promise associated with each node identifies a number of transmission channels that are promised to be made available for allocation to the node in each transmission frame.

6. The method of claim 1, wherein the promise associated with at least one of the nodes is based on a purchased level of service for the node.

7. The method of claim 1, wherein at least one of the first allocation and second allocation is based on priorities associated with the requesting nodes.

8. The method of claim 7, wherein at least one of the promise and the priority associated with at least one of the nodes is based on a type of application being run on the node.

9. The method of claim 7, wherein the priorities associated with the requesting nodes are determined based on a priority of a group of nodes within which each requesting node is assigned.

10. The method of claim 9, wherein the priorities associated with the requesting nodes are further determined based on a priority of each node within the group of nodes that the node is assigned.

11. The method of claim 1, wherein the promise associated with at least one of the nodes is based on one or more bandwidth requirements for proper performance of the node.

12. The method of claim 1, including simulating models of nodes of the network to determine a preferred set of priorities associated with the nodes of the network.

13. The method of claim 1, wherein the machine is one of the nodes of the network.

14. The method of claim 1, wherein
the machine is a simulation machine,
the nodes are models of network devices, and
the method includes determining one or more performance measures associated with the transmission of data from the requesting nodes based on the allocations to facilitate a selection of at least one of the priorities and promises associated with the nodes based on the one or more performance measures.

15. A simulation system comprising:
a memory that is configured to store information related to:
channel sharing among nodes of a modeled network,
promises associated with the nodes of the network,
models associated with the nodes of the network, and
traffic associated with the nodes of the network; and
a processor that is configured to:
simulate receiving requests from a plurality of requesting nodes for allocation of transmission channels within a transmission frame, based on the traffic associated with the nodes of the network,
provide a first allocation of dedicated transmission channels in response to the requests based on a promise of dedicated channels associated with each requesting node,
provide a second allocation of dynamic transmission channels in response to requests in excess of the promise associated with each requesting node,
simulate broadcasting of the first and second allocations to the plurality of nodes,
simulate transmission of data from the requesting nodes based on the first and second allocations and corresponding reception of the data at destination nodes, and
provide one or more measures of performance based on the transmission and reception of the data,
wherein the first and second allocations include one or more allocations of a same transmission channel to a plurality of requesting nodes, based on the information related to channel sharing.

16. The system of claim 15, wherein the processor is configured to:
provide a third allocation of available transmission channels remaining after the first and second allocations, and
simulate transmission of data based on the third allocations and corresponding reception of the data at destination nodes.

17. The system of claim 15, wherein information related to channel sharing includes sets of non-sharing nodes, and the processor is configured to:
simulate receipt of connectivity information from the nodes, and
determine the sets of non-sharing nodes based on the connectivity information, each set identifying nodes that are not permitted to share a transmission channel, at least some of the nodes in the plurality of nodes being permitted to share a transmission channel.

18. The system of claim 17, wherein the processor is configured to determine the sets of non-sharing nodes by identifying nodes that are in direct communication with each other and identifying nodes that are in direct communication with a common other node.

19. The system of claim 17, wherein the processor is configured to determine the sets of non-sharing nodes by creating a directed graph based on the connectivity information.

20. The system of claim 15, wherein the promise associated with each node identifies a number of transmission channels that are promised to be made available for allocation to the node in each transmission frame.

21. The system of claim 15, wherein the promise associated with at least one of the nodes is based on a purchased level of service for the node.

22. The system of claim 15, wherein at least one of the first allocation and second allocation is based on priorities associated with the requesting nodes.

23. The system of claim 22, wherein at least one of the promise and the priority associated with at least one of the nodes is based on a type of application being run on the node.

24. The system of claim 22, wherein the priorities associated with the requesting nodes are determined based on a priority of a group of nodes within which each requesting node is assigned.

25. The system of claim 24, wherein the priorities associated with the requesting nodes are further determined based on a priority of each node within the group of nodes that the node is assigned.

26. The system of claim 15, wherein the promise associated with at least one of the nodes is based on one or more bandwidth requirements for proper performance of the node.

27. A communications device comprising:
a memory that is configured to store information related to:
channel sharing among nodes of a network, and
promises associated with the nodes of the network, and
a processor that is configured to:
receive requests from a plurality of requesting nodes for allocation of transmission channels within a transmission frame, based on the traffic associated with the nodes of the network,
provide a first allocation of dedicated transmission channels in response to the requests based on a promise of dedicated channels associated with each requesting node,
provide a second allocation of dynamic transmission channels in response to requests in excess of the promise associated with each requesting node, and
broadcast the first and second allocations to the plurality of nodes to enable the transmission of data from the requesting nodes based on these allocations,
wherein the first and second allocations include one or more allocations of a same transmission channel to a plurality of requesting nodes, based on the information related to channel sharing among the nodes.

28. The device of claim 27, wherein the processor is configured to provide a third allocation of available transmission channels remaining after the first and second allocations.

29. The device of claim 27, wherein the information related to channel sharing includes sets of non-sharing nodes, and the processor is configured to:
receive connectivity information from the nodes, and
determine the sets of non-sharing nodes based on the connectivity information based on the connectivity information, each set identifying nodes that are not permitted to share a transmission channel, at least some of the nodes in the plurality of nodes being permitted to share a transmission channel.

30. The device of claim 29, wherein the processor is configured to determine the sets of non-sharing nodes by identifying nodes that are in direct communication with each other and identifying nodes that are in direct communication with a common other node.

31. The device of claim 29, wherein the processor is configured to determine the sets of non-sharing nodes by creating a directed graph based on the connectivity information.

32. The device of claim 27, wherein the promise associated with each node identifies a number of transmission channels that are promised to be made available for allocation to the node in each transmission frame.

33. The device of claim 27, wherein the promise associated with at least one of the nodes is based on a purchased level of service for the node.

34. The device of claim 27, wherein at least one of the first allocation and second allocation is based on priorities associated with the requesting nodes.

35. The device of claim 34, wherein at least one of the promise and the priority associated with at least one of the nodes is based on a type of application being run on the node.

36. The device of claim 34, wherein the priorities associated with the requesting nodes are determined based on a priority of a group of nodes within which each requesting node is assigned.

37. The device of claim 36, wherein the priorities associated with the requesting nodes are further determined based on a priority of each node within the group of nodes that the node is assigned.

38. The device of claim 27, wherein the promise associated with at least one of the nodes is based on one or more bandwidth requirements for proper performance of the node.
